(19) United States
(12) Patent Application Publication
(10) Pub. No.: US 2025/0354064 A1
(43) Pub. Date: Nov. 20, 2025

(54) SYSTEMS AND METHODS FOR PREDICTING ONE OR MORE PARAMETERS OF PETROLEUM COKE BASED ON ONE OR MORE PARAMETERS OF AN ASSOCIATED COKE PRODUCTION SYSTEM

(71) Applicant: BP Corporation North America Inc., Houston, TX (US)

(72) Inventors: Elizabeth Davis, Bellingham, WA (US); Barbara Cramer, Blaine, WA (US); Richard E. Johnson, Lynden, WA (US); Corey Vannoy, Bellingham, WA (US)

(73) Assignee: BP Corporation North America Inc., Houston, TX (US)

(21) Appl. No.: 19/210,916

(22) Filed: May 16, 2025

Related U.S. Application Data
(60) Provisional application No. 63/649,165, filed on May 17, 2024.

(51) Int. Cl. C10B 45/00

(52) U.S. Cl. CPC C10B 45/00

(57) ABSTRACT

A computer-implemented method for predicting one or more parameters of calcinated coke produced by a coke production system includes acquiring data indicative of at least one of one or more feedstock properties, one or more coke heating properties, or one or more coke storage properties, inputting the acquired data into a coke predictive model, and providing by the coke predictive model one or more predicted coke parameters corresponding to a feedstock received by the coke production system and based on the acquired data.

### CROSS-REFERENCE TO RELATED APPLICATIONS

This application claims benefit of U.S. provisional patent application Ser. No. 63/649,165 filed May 17, 2024, and entitled “Systems and Methods for Predicting One or More Parameters of Petroleum Coke Based on One or More Parameters of an Associated Coke Production System,” which is hereby incorporated herein by reference in its entirety for all purposes.

### STATEMENT REGARDING FEDERALLY SPONSORED RESEARCH OR DEVELOPMENT

Not applicable.

### BACKGROUND

The hydrocarbon-based energy source commonly referred to as “coke” is a solid carbonaceous material derived from the thermal decomposition of coal or via refining of petroleum-based products. Coke may be produced by subjecting a carbonaceous material (e.g., coal, a heavy “cut” or fraction of an initial petroleum feedstock) to one or more chemical reactions such as “coking” or thermal cracking processes in which volatile substances are removed from the carbonaceous material, resulting in a dense, carbon-rich residue in the form of coke. In addition, coke is widely used as a fuel source due to its high carbon content and calorific value. For example, coke plays a crucial role in the metallurgical industry (e.g., in the production of iron, aluminum, and steel) where it serves as both a fuel and a reducing agent in blast furnaces. However, applications for coke extend at least to power generation and other industrial processes requiring high-temperature heat sources.

### SUMMARY

An embodiment of a computer-implemented method for predicting one or more parameters of calcinated coke produced by a coke production system comprises (a) acquiring data indicative of at least one of one or more feedstock properties, one or more coke heating properties, or one or more coke storage properties, (b) inputting the acquired data into a coke predictive model, and (c) providing by the coke predictive model one or more predicted coke parameters corresponding to a feedstock received by the coke production system and based on the acquired data. In some embodiments, the one or more coke parameters comprises a shot coke parameter. In some embodiments, the method comprises (d) providing an alarm to a user of the coke predictive model in response to the shot coke parameter equaling or exceeding a predefined threshold. In certain embodiments, the one or more coke parameters comprises a vibrated bulk density parameter. In certain embodiments, the one or more coke parameters comprises a particle size parameter. In some embodiments, the one or more feedstock properties includes at least one of a volatile matter property, a density property, a characterization factor property, a sulfur content property, a water content property, or a total acid number (TAN) property. In some embodiments, the one or more coke heating properties comprises at least one of an air temperature property, an air flowrate property, a green coke flowrate property, or a heater operating temperature property. In certain embodiments, the one or more coke storage properties comprises a storage duration property, a storage location property, or a pile condition property. In certain embodiments, the one or more predicted coke parameters are produced by the coke predictive model in real-time following (b).

An embodiment of a computer-implemented method for predicting one or more parameters of calcinated coke produced by a coke production system comprises (a) acquiring data indicative of at least one of one or more feedstock properties, one or more coke heating properties, or one or more coke storage properties, (b) inputting the acquired data into a trained machine learning model, and (c) providing by the trained machine learning model one or more predicted coke parameters corresponding to a feedstock received by the coke production system and based on the acquired data. In some embodiments, the method comprises (d) acquiring one or more target coke parameters associated with the calcinated coke produced by the coke production system, and (e) applying the one or more acquired target coke parameters to a machine learning algorithm to produce the trained machine learning algorithm. In some embodiments, both the one or more predicted coke parameters and the one or more target coke parameters comprises at least one of a shot coke parameter, a vibrated bulk density parameter, or a particle size parameter. In certain embodiments, (e) comprises applying both the acquired target parameters and at least some of the acquired data that has been correlated with the calcinated coke associated with the one or more acquired target coke parameters. In certain embodiments, the one or more feedstock properties includes at least one of a volatile matter property, a density property, a characterization factor property, a sulfur content property, a water content property, or a total acid number (TAN) property. In some embodiments, the one or more coke storage properties comprises a storage duration property, a storage location property, or a pile condition property. In some embodiments, the one or more predicted coke parameters are produced by the trained machine learning model in real-time following (b).

An embodiment of a system comprises one or more processors, and a storage device coupled to the one or more processors, the storage device configured to store instructions that, when executed by the one or more processors, configure the one or more processors to (a) acquire data indicative of at least one of one or more feedstock properties, one or more coke heating properties, or one or more coke storage properties, (b) input the acquired data into a coke predictive model, and (c) provide by the coke predictive model one or more predicted coke parameters corresponding to a feedstock received by a coke production system and based on the acquired data. In certain embodiments, the one or more predicted coke parameters comprises at least one of a shot coke parameter, a vibrated bulk density parameter, or a particle size parameter. In certain embodiments, the one or more feedstock properties includes at least one of a volatile matter property, a density property, a characterization factor property, a sulfur content property, a water content property, or a total acid number (TAN) property. In some embodiments, the one or more coke storage properties comprises a storage duration property, a storage location property, or a pile condition property.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of disclosed exemplary embodiments, reference will now be made to the accompanying drawings in which:

FIG. 1 is a block diagram of an embodiment of a coke production system in accordance with principles disclosed herein;

FIG. 2 is a block diagram of an embodiment of a coker unit in accordance with principles disclosed herein;

FIG. 3 is a schematic view of an embodiment of a coke receptacle map in accordance with principles disclosed herein;

FIG. 4 is a block diagram of an embodiment of a coke quality prediction system in accordance with principles disclosed herein;

FIGS. 5 and 6 are flowcharts of embodiments of methods for predicting one or more parameters of calcinated coke produced by a coke production system in accordance with principles disclosed herein;

FIG. 7 is a block diagram of a computer system in accordance with principles disclosed herein; and

FIG. 8 is a chart illustrating predicted shot coke percentage for each of a plurality of different days for a selected coke production system in accordance with principles disclosed herein.

### DETAILED DESCRIPTION

The following discussion is directed to various embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection as accomplished via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Additionally, the term “about” is intended to cover deviations of +/−5%.

As described above, coke is a carbon-rich solid material derived from subjecting a carbonaceous feedstock to one or more chemical reactions that may be driven by temperature, pressure, and/or other parameters. For instance, coke includes petroleum coke or simply “petcoke” derived from a fluidic petroleum feedstock that is subjected to a chemical reaction in the form of “cracking” in which organic molecules (e.g., kerogens, long-chain hydrocarbons) are broken down or “cracked” (e.g., via breaking of carbon-carbon bonds) into relatively simpler and smaller molecules such as light hydrocarbons. This cracking process may be driven by elevated temperature and implemented by a “coker” unit or coke production system (e.g., a unit or subsystem of a larger facility or refinery for processing the petroleum feedstock) configured to produce a coke product (e.g., the outcome of the cracking process) from a fluidic petroleum feedstock (e.g., a petroleum product, a heavy fraction of a petroleum product).

The microstructure of the resulting coke product may vary substantially, materially impacting the performance of the coke product such as, for example, the amount of energy produced from consuming the coke product, the usability of the coke product such as the difficulty in refining, transporting, storing, and/or consuming the coke product, and safety and/or environmental concerns related to the coke product. Particularly, coke is known to manifest in at least four basic types: needle coke, honeycomb coke, sponge coke, and shot coke, where “fuel-grade” coke consumable as an energy source typically comprises either sponge or shot coke.

Shot coke may be formed when residual oil is processed through delayed coking with specific operating conditions that favor rapid cooling of the resulting coke product. This rapid quenching of the coke creates a dense, hard, and spherical form of coke, resembling tiny pellets or “shot.” Due to its high sulfur content and hardness, shot coke is less desirable for metallurgical applications and is often used as a fuel source in power plants or cement kilns, where the emission control systems can manage the sulfur content. As used herein, the term “shot coke” refers to the petroleum coke having a generally spheroidal morphology with a maximum diameter of approximately 10 millimeters (mm).

On the other hand, sponge coke has a more porous and sponge-like structure as compared to shot coke. Sponge coke is less dense and softer than shot coke, with a texture generally resembling that of a hard sponge. The relatively greater porosity of sponge coke makes it more suitable for metallurgical applications, where it can be used in steel and aluminum smelting as a reducing agent and anodes. In addition, sponge coke is often preferred in these industries due to its lower sulfur content and ability to efficiently release volatile components, providing the high temperatures required in metallurgical processes.

A given petroleum feedstock may produce more than one type of coke (e.g., sponge or shot coke) at a given time when subjected to a coke production process implemented by a corresponding coke production system. For instance, a given batch of coke product produced by a coke production system from a given petroleum feedstock may contain different forms of coke in varying proportions contingent on the configuration and implementation of the coke production system, and characteristics of the petroleum feedstock received by the coke production system. Further, in some instances, it may be desired to alter either the coke production system, its manner of implementation, or one or more parameters of the petroleum feedstock in order to tune the composition of the coke product produced therefrom. For example, it may be desirable to minimize or maximize the proportion of shot coke contained in the coke product along with other parameters.

Accordingly, embodiments of systems and methods are disclosed herein for predicting one or more parameters of coke produced by a coke production system based on one or more properties of the coke production system such as the feedstock and operating parameters of equipment of the coke production system. Particularly, coke quality prediction methods disclosed herein may include applying one or more properties contained in an input dataset to a predictive model, the input dataset associated with a selected coke production system, and generating, by the predictive model, one or more predicted coke parameters for coke produced by the coke production system. In some embodiments, the one or more coke parameters comprises at least one of shot coke percentage, vibrated bulk density, and particle size distribution.

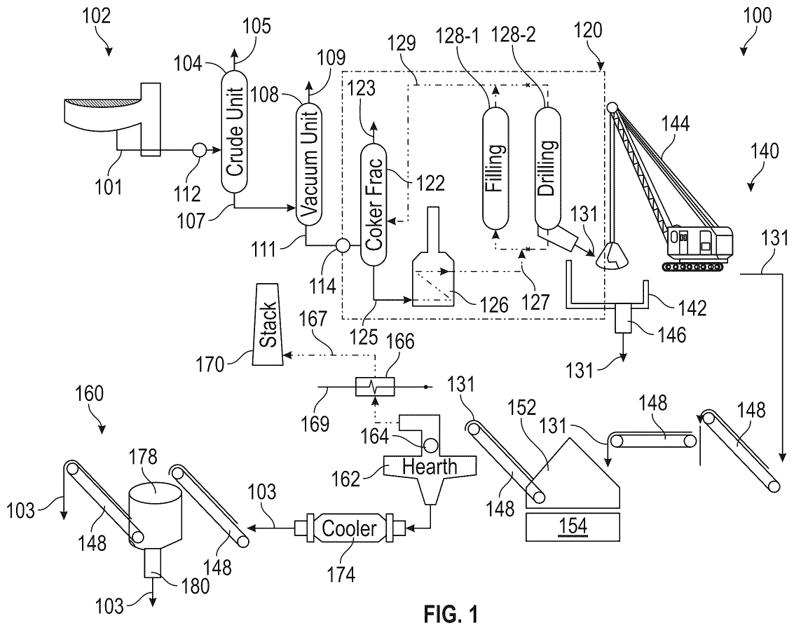

Referring now to FIG. 1, an embodiment of a coke production system 100 is shown. Coke production system 100 is generally configured to produce a final coke product 103 from an input feedstock comprising a crude oil or petroleum feedstock 101. Initially, it may be understood that coke production system 100 shown in FIG. 1 is merely exemplary and presented for the sake of discussion and embodiments of systems and methods for predicting one or more parameters of a coke product may be implemented in the context of coke production systems (or other hydrocarbon systems which produce a coke product from an input feedstock) that vary substantially in configuration from the system 100 shown in FIG. 1.

In this exemplary embodiment, coke production system 100 generally includes a distillation unit 102 which receives a stream of the petroleum feedstock 101, a coke production or coker unit 120 that receives an output of the distillation unit 102, a coker unit 140 that receives an output of the coker unit 120, and a coke distribution unit 160 that receives an output of the coker unit 120 and produces or discharges the final coke product 103. Distillation unit 102 includes an atmospheric unit 104 (also known as crude unit 104) and vacuum unit 108. Atmospheric unit 104 outputs comprise atmospheric overhead hydrocarbons 105 and reduced oil 107. Vacuum unit 108 outputs comprise vacuum overhead hydrocarbons 109 and vacuum residual 111.

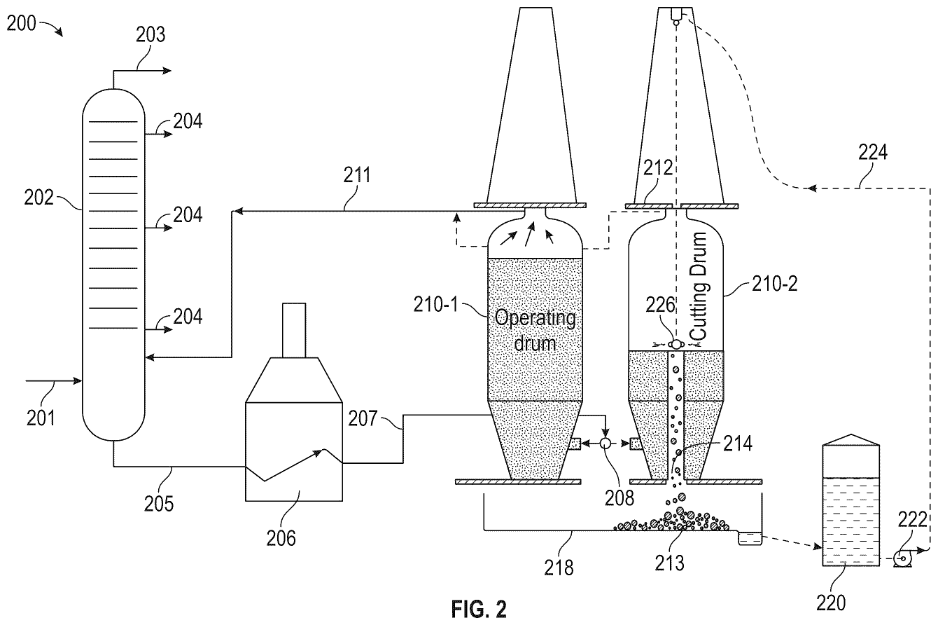

Coker unit 120 (discussed in further detail in FIG. 2, infra) includes coke fractionator (frac) 122, a coke heater or furnace 126, and coke drums 128. Coker unit 120 comprises a pair of coke drums labeled as 128-1 and 128-2 in FIG. 1; however, in other embodiments, coker unit 120 may include a single coke drum 128 or more than two coke drums 128. Coke fractionator 122 outputs include coker overhead hydrocarbons 123 and coker residual 125. Coke furnace 126 outputs include heated residual 127. Coke drums 128 comprise operating drum 128-1 (aka filling drum 128-1) and cutting drum 128-2 (aka drilling drum 128-2). Coke drums 128 outputs comprise drum overhead hydrocarbons 129 and initial or “green” coke 131.

Coke production system 100 utilizes a series of separate unit operations (e.g., implemented by units 102, 120, 140, and 160) designed to separate and process the petroleum feedstock 101 into the final coke product 103. Petroleum feedstock 101 received by the distillation unit 102 of coke production system 100 may comprise various types of crude oil or blends thereof containing a range of separate hydrocarbons including both so-called “light” hydrocarbons having a relatively low density or molecular weight (e.g., methane, ethane, propane, and butane) and so-called “heavy” hydrocarbons having a relatively greater density or molecular weight such as bitumen. Various pre-processing steps (not shown) may be performed on the petroleum feedstock 101 during crude oil pre-processing (not depicted) to refine the petroleum feedstock 101 prior to input into coke production system 100. These pre-processing steps may include, but are not limited to, desalting, dehydration, and distillation, depending on the specific characteristics of the petroleum feedstock 101.

Petroleum feedstock 101 is fed into distillation unit 102. Distillation unit 102 is configured to implement a distillation process to separate petroleum feedstock 101 into various fractions based on their respective phase-change characteristics. Particularly, the atmospheric unit 104 divides petroleum feedstock 101 into atmospheric light or overhead hydrocarbons 105 discharged from a vertically upper end of atmospheric unit 104 and a reduced oil 107 discharged from an opposing vertically lower end of atmospheric unit 104. Similarly, vacuum unit 108, which may operate at a lower operating pressure (e.g., at a vacuum) than atmospheric unit 104 to promote further separation of the components of the reduced oil 107. Vacuum unit 108 divides reduced oil 107 into vacuum overhead hydrocarbons 109 discharged from a vertically upper end of vacuum unit 108 and a vacuum residual 111 discharged from an opposing vertically lower end of vacuum unit 108.

In this exemplary embodiment, a product exiting distillation unit 102 is a vacuum residual or residual 111. Vacuum residual 111 is supplied to the coker fractionator 122 of coker unit 120 which divides vacuum residual 111 into coker overhead hydrocarbons 123 discharged from a vertically upper end of coker fractionator 122 and a coker residual 125 discharged from an opposing vertically lower end of coker fractionator 122. Coker residual 125 comprises heavy hydrocarbon fractions suitable for further coke processing. Other lighter fractions (e.g., atmospheric overhead hydrocarbons 105, vacuum overhead hydrocarbons 109, and coker overhead hydrocarbons 123) may also be produced by units 102 and 120, but not all are depicted in detail in FIG. 1. Additionally, in this exemplary embodiment, coke production system 100 comprises a feedstock sensor module 112 and a coker sensor module 114. Sensor modules 112 and 114 may each comprise one or more electronic sensors along with supporting hardware such as communication equipment for transmitting data generated by sensor modules 112 and 114, and/or memory for logging data generated by sensor modules 112 and 114. Data generated by sensor modules 112 and 114 may be communicated in real-time (e.g., within one second) or near real-time in some embodiments, stored and transmitted in predefined batches as batch data in other embodiments, and stored as logged data and only later manually retrieved in still other embodiments. In this exemplary embodiment, feedstock sensor module 112 is configured to monitor one or more parameters of petroleum feedstock 101 (e.g., as petroleum feedstock 101 is received by distillation unit 102). while vacuum residual (resid) properties are measured at the inlet of coke fractionator 122 by coker sensor module 114, which is the input point into coker unit 120 of coke production system 100. For example, sensor modules 112 and 114 may measure temperature, pressure, flow rate, density, and/or other parameters of petroleum feedstock 101 and vacuum residual 111, respectively. For example, in other embodiments, sensor modules 112 and 114 (or other sensor modules of system 100) may incorporate spectroscopic sensors configured to collect spectroscopic data containing spectral components and from which a composition of the material (e.g., fluid) may be inferred or estimated.

The coker residual 125 exits the coke fractionator 122 and is directed into a coke furnace 126. The coke furnace 126 is a heated vessel that thermally cracks the long-chain hydrocarbon molecules present in the coker residual 125 into smaller molecules. This thermal cracking process promotes the formation of coke precursors within the coker residual 125.

The heated coker residual 125 exits the coke furnace 126 and is directed into coke drums 128. Particularly, coke drums 128 may operate in an alternating fashion. While one drum is being filled with the processed resid stream from the coke furnace 126, the other drum undergoes a coke-cutting process as will be discussed further herein. The coke-cutting process serves to remove a freshly solidified coke product in the form of green coke 131 which falls via gravity from the given coke drum 128 that has completed its coking cycle and into a coke receptacle (e.g., a pit, a pad, one or more rail cars) 142 of the coker unit 140 of coke production system 100.

The coke-cutting process (not shown in FIG. 1, but depicted in FIG. 2 infra) utilizes a high-pressure fluid stream to break apart the solidified coke within the drum. The resulting green coke 131 falls from the cutting drum 128-2 into a coke receptacle 142 for further handling. Green coke refers to the unprocessed coke product obtained after the initial coking stage. Green coke typically contains significant moisture and requires further processing steps before reaching its final form as a commercial product. Thus, the green coke 131 that falls from the cutting drum 128-2 is typically a wet, fragmented material that requires removal from the coke receptacle 142 using mechanical equipment, such as a crane 144, front-end loader (not shown), and/or conveyors 148.

To provide an additional example, and referring to FIG. 2, another embodiment of a coker unit or system 200 is shown. Coker unit 200 may be incorporated into a larger fluid system in some embodiments such as a coke production system. The schematic of coker unit 200 shown in FIG. 2 focuses on the pathways of hydrocarbon streams (e.g., coker residual 125) from a coker fractionator 202 of coker unit 200 (similar to coke fractionator 122 in FIG. 1 in some embodiments) of coker unit 200 to a coke receptacle or pit 218 (similar to coke receptacle 142 in FIG. 1 in some embodiments) of coker unit 200. In this exemplary embodiment, coker unit 200 also includes a coker fractionator 202 (similar to coker fractionator 122 in FIG. 1 in some embodiments),a coke furnace 206 (similar to coke furnace 126 in FIG. 1 in some embodiments), a three-way valve 208, coke drums 210 (similar to coke drums 128 in FIG. 1 in some embodiments), a cutting fluid storage tank or receptacle 220, a cutting fluid pump 222 configured to receive cutting fluid from the cutting fluid storage tank 220, a fluid line or conduit 224 fluidically connected between a discharge of the cutting fluid pump 222 and coke drums 210, rotary cutting elements 226 (only one of which is shown in FIG. 2).

In this exemplary embodiment, an inlet of coker fractionator 202 receives a petroleum feedstock 201. Petroleum feedstock 201 may comprise a vacuum residual such as vacuum residual 111 shown in FIG. 1, but does not necessarily need to be crude oil. For instance, in other embodiments, feedstock 201 may comprise slop oils, waste hydrocarbon streams, biofeeds and the like. Coker residual 205 (similar to coker residual 125 in FIG. 1 in some embodiments) exits coker fractionator 202 at a vertically lower end thereof and is directed into coke furnace 206. Among other outputs, the coker fractionator 202 may also discharge overhead fraction hydrocarbons 203 from a vertically upper end thereof (e.g., fuel gas & LPG to feed to a gas plant) and one or more intermediate fraction hydrocarbons 204 (e.g., coker naphtha, light coker gas oil (LCGO), and/or heavy coker gas oil (HCGO)) discharged vertically between overhead fraction hydrocarbons 203 and coker residual 205.

The coker residual 205 discharged from coker fractionator 202 enters coke furnace 206 which thermally cracks long-chain hydrocarbon molecules in the resid stream into smaller molecules, promoting coke precursor formation, and forming heated coker residual 207. The heated coker residual 207 exits the coke furnace 206 and is directed into one of the coke drums 210 of coker unit 200. As previously discussed, such coke drums 210 may operate alternatively, with one drum being filled while the other undergoes a coke-cutting process, or at the same time.

Three-way valve 208 may allow for movement of heated coker residual 207 between the coke drums 210. At any one time, the operating drum (e.g., coke drum 210-1 in FIG. 2) may be filled from the coke furnace 206 using three-way valve 208, while the cutting drum (e.g., coke drum 210-2 in FIG. 2) may be drilled using one of the cutting elements 226 (each coke drum 210 may be equipped with its own cutting element 226) to empty the cutting drum of green coke 213.

Particularly, in this exemplary embodiment, the operation of coke drums 210 are staged whereby one of the coke drums 210 (coke drum 210-1 in FIG. 2) inhabits an operating state while the other coke drum 210 (shown as coke drum 210-2 in FIG. 2) is in a cutting state. In the operating state, the given coke drum 210 is filled with coker residual 207. Following filling, the coke drum 210 in the operational state may be partially enclosed where the coker residual 207 within is maintained for a predefined period of time as the coker residual 207 continues to thermally crack, releasing vaporous hydrocarbons that are recirculated as drum overhead hydrocarbons 211 to the coker fractionator 202.

Following completion of the predefined time period, the coke drum 210 transitions from the operating state to the cutting state whereby cutting element 226 is deployed to cut into the green coke now formed within the coke drum 210. Drilling of the green coke 213 may be performed using a high-pressure fluid jet via fluid line 224 extending through a vertically upper opening 212, and a rotary cutting element 226 configured to direct a jet of cutting fluid onto solidified green coke 213. The fluid line 224 is partially fed by a cutting fluid pump 222 which utilizes fluid from a cutting fluid storage tank (or receptacle) 220. The fluid storage receptacle may also partly utilize excess fluid drained from the coke receptacle 218. The cutting fluid pump 222 produces high-pressure cutting fluid that, in conjunction with the rotary cutting element 226, breaks apart the solidified green coke 213 within the coke drum 210. The resulting green coke 213 falls from the cutting drum 210-2 through a vertically lower opening or chute 214 into the coke receptacle 218 for further handling. Fluid used in this process may be water or any other liquid suitable for drilling and breaking apart solidified green coke into green coke 213. The coke drum 210 may return to the operating state from the cutting state once the cutting element 226 has completed its removal of green coke 213 from the coke drum 210.

While FIG. 2 provides a zoomed-in view of a specific embodiment of the coking process focusing on the pathways from the coker fractionator 122 to the coke drums 128, potential alternative depictions within the scope of the disclosure should be considered. For example, alternative embodiments may comprise additional components within the system, such as distillation columns, heat exchangers, and product withdrawal points, to provide a more thorough fractionation process. Also, alternative embodiments may comprise employing heating technology, such as furnace with burners or a heat exchanger configuration utilizing hot process streams. Also, as discussed earlier, alternative embodiments may comprise a single, larger coking drum design, rather than a pair of coke drums 128. Additionally, there may be additional configurations in the coking drums, such as agitators or specific features related to the coke-cutting process (not shown in FIG. 2). Further, alternative embodiments could include additional elements like instrumentation and control systems that are crucial for monitoring and regulating the coking process parameters.

Returning to FIG. 1, in this exemplary embodiment, coker unit 140 generally comprises coke receptacle 142 (aka coke receptacle 142), a lifting device or crane 144, green coke sampling station 146, and barn storage area 152 (aka coke storage unit 152). Additionally, in this exemplary embodiment, coke distribution unit 160 generally comprises a coke heating unit or hearth 162, heat exchanger 166, exhaust stack 170, coke cooling unit 174, storage silo 178, and final coke sampling station 180. Conveyors 148, which are comprised in both coker unit 140 and coke distribution unit 160, may comprise conveyor belts or other conveyance mechanisms to aid in the transport of various stages of coke products. Coke heating unit 162 comprises a hearth (e.g., a rotary hearth), in some embodiments. Mechanisms used to transport final coke product 103 or “green” coke 131 outside the system may include trucks, railcars, or ships for transportation to customers who utilize coke in various industrial applications. Arrows in FIG. 1 indicate pipes, pipelines, or other transport mechanisms.

In this exemplary embodiment, coke production system 100 comprises a hearth sensor module 164 comprising one or more electronic sensors along with supporting hardware such as communication equipment for transmitting data generated by hearth sensor module 164, and/or memory for logging data generated by hearth sensor module 164. Data generated by hearth sensor module 164 may be communicated in real-time/near real-time in some embodiments, stored and transmitted in predefined batches as batch data in other embodiments, and stored as logged data and only later manually retrieved in still other embodiments. In this exemplary embodiment, hearth sensor module 164 is configured to monitor one or more operating parameters of coke heating unit 162 such as, for example, flow rate of the green coke 131 entering coke heating unit 162, an air feed temperature of unit 162, a soaking pit temperature of unit 162, and/or a hearth speed of coke heating unit 162.

During this coke-cutting process, the high-pressure fluid stream may generate shot coke, a fragmented and potentially hazardous form of coke. The processed green coke 131 accumulated within the coke receptacle 142 may then be sampled and/or tested to quantify the percentage of shot coke content. The shot coke content may be a valuable parameter for a shot coke use case in which an objective is to develop a model capable of predicting the percentage of shot coke present in the green coke 131 produced by the coke drums 128. The disclosed prediction model may leverage data on the properties of crude oil feedstock and/or the coker residual 125 as input variables.

In this exemplary embodiment, final coke product 103 (e.g., calcinated coke) may be sampled from the final coke sampling station 180. Similar to the sampled green coke 131 described above, the sampled final coke product 103 may be tested to estimate one or more parameters of the final coke product 103 including, for example, the relative amount of shot coke contained in the final coke product 103, the vibrated bulk density (VBD) of the final coke product 103, and the particle size of the final coke product 103. In some embodiments, final coke sampling station 180 may comprise an automated sampling station configured to automatically acquire samples of final coke product 103, mechanized, or manual with station 146 serving to provide manual access to the final coke product 103 for sampling.

A crane 144 picks up the green coke 131 from the coke receptacle 142 in this exemplary embodiment. Crane 144 may be a heavy-duty crane specifically designed for handling large and potentially heavy materials like green coke. Crane 144 then deposits the green coke 131 onto a designated conveyor 148. A conveyor belt on the conveyor 148 may act as a moving platform that continuously transports the green coke 131 to the following processing stage. The conveyor belt may feed the green coke 131 into a crusher or grinder (not shown) so that the green coke 131 may then undergo size reduction. The grinder is a mechanical device equipped with crushing elements that break down large green coke 131 boulders into smaller, more manageable pieces. This size reduction may facilitate further processing and transportation. The green coke 131 is then transferred onto another conveyor 148 for transport to designated storage areas which may take the form of one or more uncovered and/or covered structures such as barns, domes, and the like.

Particularly, in this exemplary embodiment, the conveyor 148 discharges the sized green coke 131 into covered structures, known as barns, in a barn storage area 152. Barn storage area 152 provides a controlled environment for the green coke 131 to dry and await further processing. In addition, the barn storage area 152 helps to protect the green coke 131 from weather elements and potentially minimize fugitive dust emissions. Excess green coke 131 may be stored in a pile outside the barn storage area 152.

In this exemplary embodiment, coke production system 100 additionally includes a coke distribution mapping system 154 configured to map the distribution of green coke 131 in the barn storage area 152 of system 100. Particularly, the coke distribution mapping system 154 may generate and continually update a coke distribution map of the quantity, source (e.g., the given coke drum), and physical location of green coke 131 in barn storage area 152 or other covered and/or uncovered coke storage areas. Coke distribution mapping system 154 may update the coke distribution map in real-time or near real-time in some embodiments, periodically at fixed intervals, in response to one or more events (e.g., the switching of the coke drums between their operational and cutting states), and/or other triggers. The information contained in the coke distribution map may be used to predict coke quality as will be discussed further herein.

The information contained in the coke distribution map may be collected using a variety of means. In some embodiments, personnel may visually inspect the barn storage area 152 and note the presence and locations of coke therein (e.g., following the unloading of a new load of coke from the coke receptacle 142). Alternatively, the process of collecting the information contained in the coke distribution map may be at least partially automated such as using one or more cameras or other optical sensors in conjunction with object detection or computer vision (CV) software.

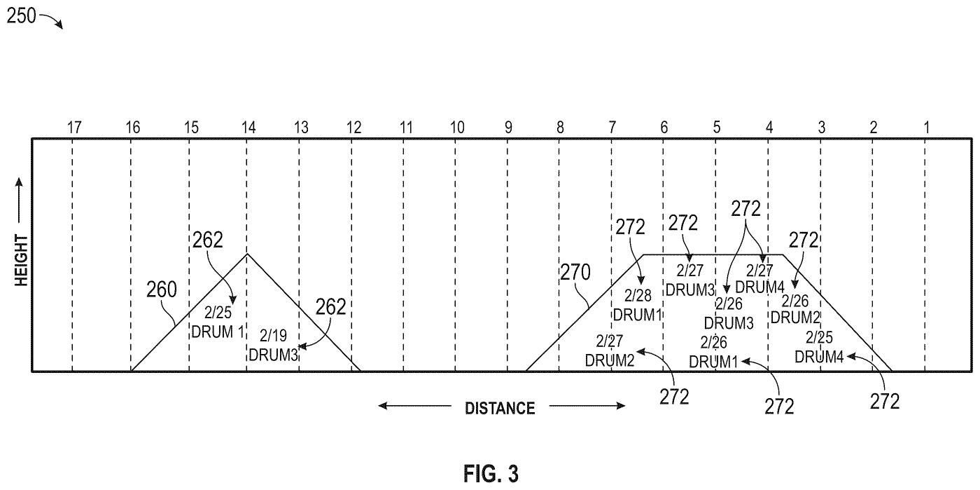

Referring to FIG. 3, an embodiment of a coke distribution map 250 is depicted. In some embodiments, coke distribution map 250 is utilized within a coking process for monitoring or recording the distribution of green coke (e.g., green coke 131 shown in FIG. 1) within designated storage areas (e.g., barn storage area 152). For instance, in some embodiments, coke distribution mapping system 154 shown in FIG. 1 may be configured to produce coke distribution maps similar, or at least having features in common with, the coke distribution map 250 shown in FIG. 3 In this exemplary embodiment, green coke distribution map 250 is a barn storage map corresponding to a coke storage barn; however, in other embodiments, coke storage distribution map 250 may be associated with another type of covered and/or uncovered coke storage area.

Green coke distribution maps, such as green coke distribution map 250, may be updated frequently or at regular intervals (e.g., every 12 hours) to maintain an updated record of green coke distribution in the coke storage area. This data, along with other relevant datasets such as petroleum feedstock (e.g., crude oil) properties and coke heating unit (e.g., hearth) operation conditions, may be utilized for further analysis and process optimization as will be discussed further herein.

In this exemplary embodiment, coke distribution map 250 illustrates a first coke pile 260 and a second coke pile 270 that is spaced from first coke pile along a longitudinal distance (e.g., along which a conveyor extends for transporting coke piles 260 and 270) within the coke barn. The amount or volume of coke located at a given position (e.g., a given location along the longitudinal distance) is represented by a vertical height of the pile 260 or 270 at the given location. As shown, coke distribution map 250 includes a plurality of first coke pile identifiers 262 associated with the first coke pile 260 and a plurality of second coke pile identifiers 272 associated with the second coke pile 270. An additional area designated as third coke pile 280, may be present outside the covered barns and signify an overflow storage location for excess green coke 131 that cannot be accommodated within the dedicated barns (for example, here, first coke pile 260 and second coke pile 270).

Identifiers 262 and 272 may contain additional information pertaining to coke piles 260 and 270, respectively, besides the amount of coke at a given position in the barn. For example, identifiers 262 and 272 may tag particular locations or areas of piles 260 and 270 with the source (e.g., which coke drum) and/or time at which the coke located at the location or area was produced. Green coke distribution map 250 utilizes shading and/or color coding to differentiate between occupied and unoccupied sections within first coke pile 260 and second coke pile 270. The visual representation allows for identification of available storage space and location of stored green coke 131. Information contained in coke distribution map 250 (including changes to coke distribution map 250 over time) may be collected and/or monitored in as will be discussed further herein to, for example, optimize the coke production system associated with coke distribution map 250.

Returning again to FIG. 1, once sufficiently dry, the green coke 131 is retrieved from the barn storage area 152 and fed into coke heating unit 162 of coke distribution unit 160 for final processing of the green coke 131 into the final coke product 103 where the final coke product 103 may be used or sold. Coke heating units (aka hearths) are typically heated chambers where the green coke 131 undergoes a process called calcination. During calcination, the remaining moisture and some volatile hydrocarbons are driven off from the green coke 131, resulting in a denser and drier final product called calcinated coke. In this embodiment, final coke product 103 in the form of calcinated coke exits coke heating unit 162, is cooled in coke cooling unit 174, and transported via conveyor 148 to one or more storage silos 178 of coke distribution unit 160. Exhaust 167 from coke heating unit 162 may be cooled via a cooling medium 169 flowing through heat exchanger 166 before being discharged by exhaust stack 170. Storage silo 178 provides enclosed storage for the final coke product 103 (i.e., the cooled calcinated coke in this embodiment) before shipment. The final coke product 103 is typically loaded onto trucks, railcars, or ships for transportation to customers who utilize coke in various industrial applications.

While FIG. 1 depicts a specific embodiment of a coke production system 100, alternative embodiments of coking processes for coke production systems exist. For example, in pre-processing, depending on the specific characteristics of the petroleum feedstock 101, additional pre-processing steps like desalting, dehydration, and atmospheric distillation may be employed within a more elaborate pre-processing unit. In another example, the coker unit 120 may utilize distillation to separate petroleum feedstock 101 into various fractions. Alternative fractionation technologies, such as solvent deasphalting, could potentially be employed depending on the desired product slate and specific refinery configuration. Further, in other embodiments, the design and operation of coke drums 128 may vary. For example, some embodiments may utilize a single, larger coke drum instead of the paired configuration shown in FIG. 1 (and FIG. 2). Additionally, alternative coke-cutting methods beyond high-pressure fluid streams may be employed, such as mechanical cutting tools. The specific equipment and methods used for green coke handling and storage (e.g., E-Crane, conveyors, barns, piles) may vary depending on factors like production capacity, space constraints, and environmental considerations. Alternative conveying systems or enclosed storage facilities may be implemented. Also, alternative embodiments for downstream processing steps may involve different drying technologies, variations in hearth (i.e., coke heating unit) design, or the use of alternative storage vessels.

Thus, it should be noted that the specific embodiment depicted in FIG. 1 can be combined with various alternative elements from different stages to create a customized coking process configuration tailored to meet a particular refinery's specific needs and constraints.

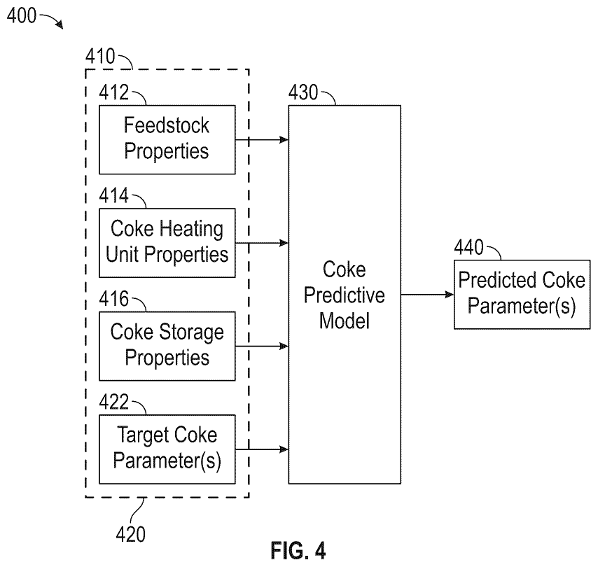

Referring to FIG. 4, an embodiment of a coke quality prediction system 400 is shown. In some embodiments, coke quality prediction system 400 is incorporated into a coking process for estimating the “quality” or one or more parameters of coke (green coke, calcinated coke) that will be produced by a selected coke production system based on one or more parameters of the coke production system including, for example, one or more parameters of the petroleum feedstock of the coke production system, and/or one or more operational parameters of equipment of the coke production system. In addition, coke quality prediction system 400 comprises an input dataset 410, a training dataset 420, a coke predictive model 430 that receives the input dataset 410 and the training dataset 420, and one or more predicted coke parameters 440 which predict the quality of coke produced by a selected coke production system.

In some embodiments, the predicted coke parameters 440 comprises a shot coke parameter corresponding to a predicted volume percentage of shot coke relative to a volume of green coke produced by the coke production system. In some embodiments, coke quality prediction system 400 may provide an alarm to a user thereof in response to the predicted volume percentage of shot coke equaling or exceeding a predefined threshold (e.g., 4% or greater, 5% or greater, 10% or greater).

In certain embodiments, the predicted coke parameters 440 comprises a VBD parameter of a green coke (e.g., green coke 131 or 213) from which a calcinated coke is ultimately produced. In some embodiments, coke quality prediction system 400 may provide an alarm to a user thereof in response to the VBD parameter falling below a predefined threshold such as, for example, below 0.91 grams per cubic centime (g/cm³), below 0.89 g/cm³ and the like.

In certain embodiments, the predicted coke parameters 440 comprises a particle size parameter which may statistically characterize the particle sizes of the calcinated coke product. For example, the particle size parameter may comprise a threshold minimum percentage of the produced calcinated coke particles having a size equal to or greater than a predefined threshold. For instance, a particle size parameter may predict that 30% of the particles of a calcinated coke product, based on input dataset 410, have a size of 5 mm or greater. Alternatively, other statistical measures for characterizing the particle size may be used for the particle size parameter such as a mean, a mode, one or more selected percentiles, one or more selected minimums and/or maximums, and the like. Additionally, in certain embodiments, coke quality prediction system 400 may provide an alarm to a user thereof in response to the particle size parameter exceeding or falling below a predefined threshold.

Input dataset 410 is specific to the selected coke production system while training dataset 420 comprises historical data associated with potentially a plurality of separate coke production systems. Training dataset 420 may be used to train the coke predictive model 430 to generate, e.g., in accordance with a predefined accuracy metric or threshold, the one or more predicted coke parameters 440 of coke produced by a selected coke production system based on the input dataset 410 associated specifically with the selected coke production system.

The input dataset 410 of coke quality prediction system 400 generally includes feedstock properties 412, coke heating unit properties 414, and coke storage properties 416, while the training dataset 420 comprises one or more target coke parameters 422. Input dataset 410 may be fed to coke predictive model 430 in real-time or at desired points or intervals of time (e.g., as batch data).

Feedstock properties 412 comprise data pertaining to the characteristics of the petroleum feedstock (e.g., petroleum feedstock 101 or 201) of the selected coke production system. The petroleum feedstock may originate from the pre-processing and/or distillation stages (e.g., while petroleum feedstock 101 is processed through distillation unit 102). The feedstock properties 412 may be predictive of one or more parameters of coke produced therefrom. Feedstock properties 412 may include, for example: a measure of the volatile matter (VM) contained in the feedstock (e.g., green coke), an aromaticity or paraffinicity (e.g., characterization or “K” factor such as Watson K factor or UOP K factor) of the feedstock, a weight or density of the feedstock (e.g., American Petroleum Institute (API) gravity), water content, sulfur content of the feedstock, corrosiveness of the feedstock due to the presence of acids (e.g., Total Acid Number (TAN)). Feedstock properties 412 may be obtained through a variety of means including, for example, sampling of the feedstock.

At least some of the properties of input dataset 410 may be collected by various sensors of the selected coke production system (e.g., via sensor modules 112 114, and/or 164) For example, coke heating unit properties 414 of input dataset 410 comprise data regarding the operating conditions within a coker unit (e.g., coker unit 120 or 200), such as coke furnace outlet temperature and residence time of petroleum feedstock within the coker unit. These values may be averaged over time to generate mean parameter values over time, for example, over the time a coke heating unit is fed with green coke. In some embodiments, the coke heating unit properties 414 may include, among others, an air temperature property (e.g., used to heat the coke within the heating unit), an air flowrate property, a green coke flowrate property, and/or a heater operating temperature property.

Coke storage properties 416 pertain to distribution properties of coke (e.g., green coke 131 or 213) stored in one or more storage areas (e.g., barn storage area 152). As discussed, this data (potentially including information on location and quantity of green coke in different storage sections) is acquired through barn maps, such as green coke storage distribution map 250 which may be generated and updated by a coke distribution mapping system of the selected coke production system. In certain embodiments, coke storage properties 416 include, among others, a storage duration property, a storage location property (e.g., information characterizing the configuration and conditions of the storage area in which the selected coke is stored), or a pile condition property. The pile condition property may characterize the pile in which the selected coke is stored within the coke storage area including, for example, the location of the selected coke within the given pile.

In some embodiments, the input dataset 410 may include additional properties such as, for example, operating temperature and/or pressure in the coke drums, velocity in the coke drum, coke drum feed rate, coke bed conditions in calciner and air conditions.

Training dataset 420 comprises one or more target coke parameters 422 which may include historical data on the quality of previously produced coke (from the same or other coke production systems) that may be used to train coke predictive model 430 to generate accurate predicted coke parameters 440 using the properties captured in input dataset 410. In some embodiments, coke predictive model 430 may provide predicted coke parameters 440 in real-time or near real-time (e.g., within a minute or less, within an hour or less, within a day or less, within a week or less, and the like) following the inputting of a corresponding input dataset 410 to coke predictive model 430.

Target coke parameters 422, which may be measured through laboratory analysis or other established methods, may comprise data related to coke yield (i.e., the estimated percentage of usable coke product obtained from the coking process) and coke strength (i.e., the predicted mechanical strength of the green coke product). The target coke parameters 422 of training dataset 420 may correspond to one or more parameters associated with coke quality and thus may correspond to the same predicted coke parameters 440 (e.g., shot coke percentage, VBD, particle size) with target coke parameters 422 being historical and thus associated with historical operating and feedstock parameters.

In some embodiments, target coke parameters 422 may include daily samples of VBD and particle size taken from a storage silo (e.g., storage silo 178) of the coke production system at the end of the calcinated coke production process and/or, in the case of shot coke, may be taken from the output of the coke receptacle (e.g., coke receptacle 142 or 218) of the coke production system. The target coke parameters 422 may be tagged or associated with the corresponding properties of the coke production system associated with the given target parameter 422. For example, a target parameter 422 corresponding to shot coke percentage may correlate (e.g., in tabular form) historical shot coke percentage for different coke production systems and their various properties (e.g., feedstock properties, coke heating unit properties, and/or coke storage properties) to facilitate the training of coke predictive model 430.

Input dataset 410 and training dataset 420 are inputted into and collectively analyzed by coke predictive model 430 with training dataset 420 used to iteratively train or improve the accuracy of coke predictive model 430 in generating predicted coke parameters 440 for a selected coke production system based on the input dataset 410 specific to the selected coke production system. Coke predictive model 430 is trained on various data, including historical data, to identify patterns and relationships between the input dataset 410 and corresponding training dataset 420 (i.e., coke quality outcomes). Through this analysis, coke predictive model 430 is able to generate predicted coke parameters 440. Thus, the output of coke predictive model 430 are predictions regarding one or more parameters of coke produced by the selected coke production system. Predicted coke parameters may include coke yield based on shot coke percentage, vibrated bulk density (VBD), and particle size, among others.

The configuration of coke predictive model 430 of coke quality prediction system 400 may vary depending on the requirements of the given application. In some embodiments, coke predictive model 430 is a regression model including a machine learning regression model. In some embodiments, coke predictive model 430 is an ensemble machine learning model comprising a plurality of separate predictive models (e.g., in the form of decision trees). In certain embodiments, coke predictive model 430 is a boosting ensemble model such as XGBoost, AdaBoost, and the like. In other embodiments, coke predictive model 430 may comprise other kinds of trained machine learning models such as neural networks and the like. In some embodiments, a given coke predictive model 430 may be trained to predict or generate a single predicted coke parameter 440 (e.g., predicted shot coke percentage for coke produced by a selected coke production system). In other embodiments, coke predictive model 430 may be trained to predict or generate a plurality of predicted coke parameters 440. In other embodiments, coke predictive model 430 may comprise predictive models other than trained machine learning models.

It should be noted that coke production systems ideally produce no more than a predefined percentage of shot coke (e.g., ˜2-10% shot coke) corresponding to a shot coke maximum where exceeding the shot coke maximum is generally deemed unacceptable. The scope of the coke quality prediction system 400 would thus, in some embodiments, be to predict the quantity of shot coke produced, as a percentage, given the properties of petroleum feedstock produced. A successful model may have a mean absolute error of 0.0047 or below in some embodiments when evaluated on the designated test set.

In addition, VBD, as referenced above, is a parameter employed to assess the packing efficiency of calcinated coke. VBD represents the mass of coke that can fill a unit volume container and is typically measured at the conclusion of the production process, prior to product sale. Higher VBD values signify a more desirable outcome. Analogous to the shot coke prediction model, a successful predictive coke quality prediction system 400 for predicting VBD achieves, in some embodiments, a mean absolute error of 0.046 or less in some embodiments when evaluated on the designated test set.

Further, particle size prediction focuses on estimating the granularity of the produced coke. Certain coking facilities establish minimum target granularities, expressed as a percentage of coke particles exceeding a specific diameter threshold. For instance, a facility might target a predefined minimum percentage of the coke particles to possess a granularity greater than a predefined target granularity. In some embodiments, coke quality prediction system 400 achieves prediction accuracy within 5% of the target value.

In some embodiments, the predicted coke parameters 440 generated by coke predictive model 430 are used to alter or optimize the selected coke production system. For example, changes in the operation of the coke production system (e.g., changes in operating pressure, temperature, feed rate, and/or flow rate for a fractionator, furnace, drums, coke heating unit, and/or other equipment) operation of the may be made in response to for instance, the shot coke percentage of the coke product exceeding a predefined shot coke maximum in an attempt to reduce the shot coke percentage for future batches of coke product. These changes may be implemented manually by personnel of the coke production system or automatically/semi-automatically using electronically controllable equipment of the system.

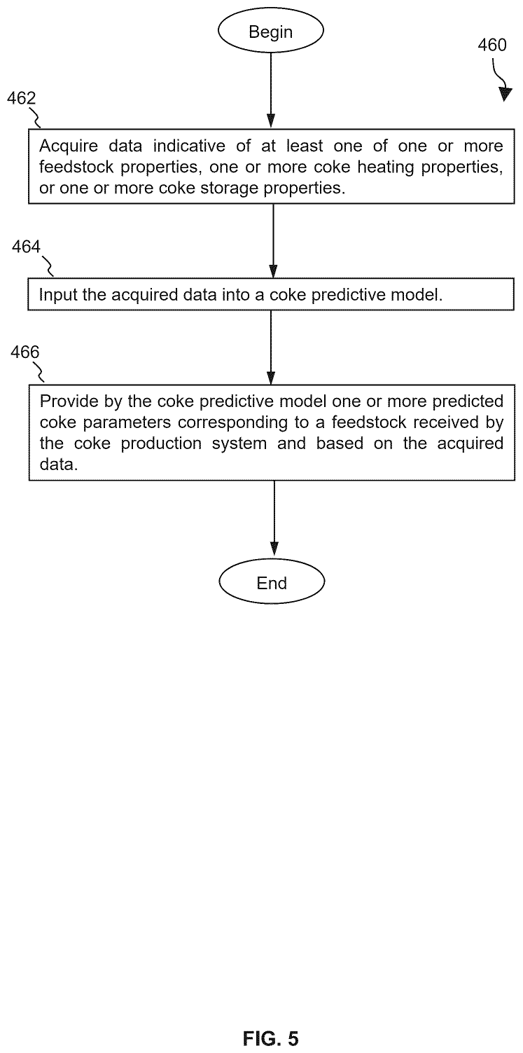

Referring to FIG. 5, an embodiment of a method 460 for predicting one or more parameters of calcinated coke (e.g., final coke product 103 shown in FIG. 1) produced by a coke production system (e.g., coke production system 100 shown in FIG. 1) is shown. Initially, at block 462, method 460 includes acquiring data indicative of at least one of one or more feedstock properties (e.g., feedstock properties 412 shown in FIG. 4), one or more coke heating properties (e.g., coke heating unit properties 414 shown in FIG. 4), or one or more coke storage properties (e.g., coke storage properties 416 shown in FIG. 4). At block 464, method 460 includes inputting the acquired data into a coke predictive model (e.g., coke predictive model 430 shown in FIG. 4). At block 466, method 460 includes providing by the coke predictive model one or more predicted coke parameters (e.g., predicted coke parameters 440 shown in FIG. 4) corresponding to a feedstock received by the coke production system and based on the acquired data.

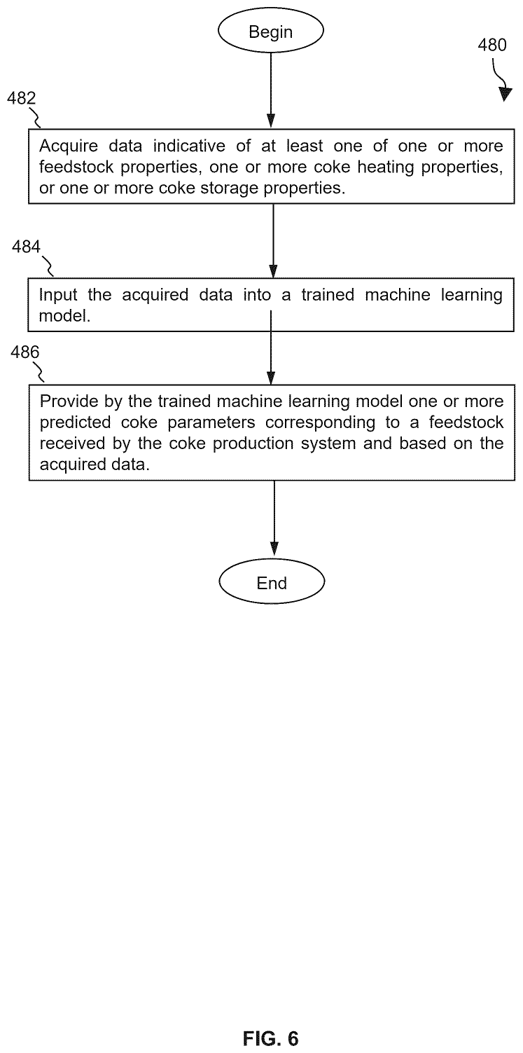

Referring to FIG. 6, an embodiment of a method 480 for predicting one or more parameters of calcinated coke (e.g., final coke product 103 shown in FIG. 1) produced by a coke production system (e.g., coke production system 100 shown in FIG. 1) is shown. Initially, at block 482, method 480 includes acquiring data indicative of at least one of one or more feedstock properties (e.g., feedstock properties 412 shown in FIG. 4), one or more coke heating properties (e.g., coke heating unit properties 414 shown in FIG. 4), or one or more coke storage properties (e.g., coke storage properties 416 shown in FIG. 4). At block 484, method 480 includes inputting the acquired data into a trained machine learning model (e.g., coke predictive model 430 shown in FIG. 4). At block 486, method 480 includes providing by the trained machine learning model one or more predicted coke parameters (e.g., predicted coke parameters 440 shown in FIG. 4) corresponding to a feedstock received by the coke production system and based on the acquired data.

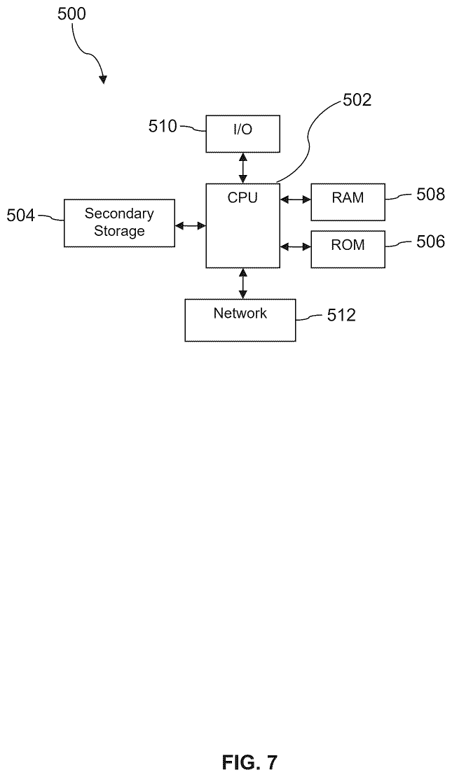

Referring now to FIG. 7, an embodiment of a computer system 500 is shown suitable for implementing one or more features disclosed herein. As an example, computer system 500 may be used to execute at least some of the features of systems 100, 200, and 400 shown in FIGS. 1, 2, and 4, such as sensor modules 112, 114, and/or 164 of coke production system 100, and coke quality prediction system 400 shown in FIG. 4. Additionally, computer system 500 may be used to execute at least some of the steps of methods 460 and 480 shown in FIGS. 5 and 6.

The computer system 500 of FIG. 7 generally includes a processor 502 (which may be referred to as a central processor unit or CPU) that is in communication with memory devices including secondary storage 504, read only memory (ROM) 506, random access memory (RAM) 508, input/output (I/O) devices 510, and network connectivity devices 512. The processor 502 may be implemented as one or more CPU chips. It is understood that by programming and/or loading executable instructions onto the computer system 500, at least one of the CPU 502, the RAM 508, and the ROM 506 are changed, transforming the computer system 500 in part into a particular machine or apparatus having the novel functionality taught by the present disclosure.

Additionally, after the system 500 is turned on or booted, the CPU 502 may execute a computer program or application. For example, the CPU 502 may execute software or firmware stored in the ROM 506 or stored in the RAM 508. In some cases, on boot and/or when the application is initiated, the CPU 502 may copy the application or portions of the application from the secondary storage 504 to the RAM 508 or to memory space within the CPU 502 itself, and the CPU 502 may then execute instructions that the application is comprised of. In some cases, the CPU 502 may copy the application or portions of the application from memory accessed via the network connectivity devices 512 or via the I/O devices 510 to the RAM 508 or to memory space within the CPU 502, and the CPU 502 may then execute instructions that the application is comprised of. During execution, an application may load instructions into the CPU 502, for example load some of the instructions of the application into a cache of the CPU 502. In some contexts, an application that is executed may be said to configure the CPU 502 to do something, e.g., to configure the CPU 502 to perform the function or functions promoted by the subject application. When the CPU 502 is configured in this way by the application, the CPU 502 becomes a specific purpose computer or a specific purpose machine.

Secondary storage 504 may be used to store programs which are loaded into RAM 508 when such programs are selected for execution. The ROM 506 is used to store instructions and perhaps data which are read during program execution. ROM 506 is a non-volatile memory device which typically has a small memory capacity relative to the larger memory capacity of secondary storage 504. The secondary storage 504, the RAM 508, and/or the ROM 506 may be referred to in some contexts as computer readable storage media and/or non-transitory computer readable media. I/O devices 510 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 512 may take the form of modems, modem banks, Ethernet cards, universal serial bus (USB) interface cards, wireless local area network (WLAN) cards, radio transceiver cards, and/or other well-known network devices. The network connectivity devices 512 may provide wired communication links and/or wireless communication links. These network connectivity devices 512 may enable the processor 502 to communicate with the Internet or one or more intranets. With such a network connection, it is contemplated that the processor 502 might receive information from the network, or might output information to the network. Such information, which may include data or instructions to be executed using processor 502 for example, may be received from and outputted to the network, for example, in the form of a computer data baseband signal or signal embodied in a carrier wave.

The processor 502 executes instructions, codes, computer programs, scripts which it accesses from hard disk, floppy disk, optical disk, flash drive, ROM 506, RAM 508, or the network connectivity devices 512. While only one processor 502 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 504, for example, hard drives, floppy disks, optical disks, and/or other device, the ROM 506, and/or the RAM 508 may be referred to in some contexts as non-transitory instructions and/or non-transitory information.

In an embodiment, the computer system 500 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

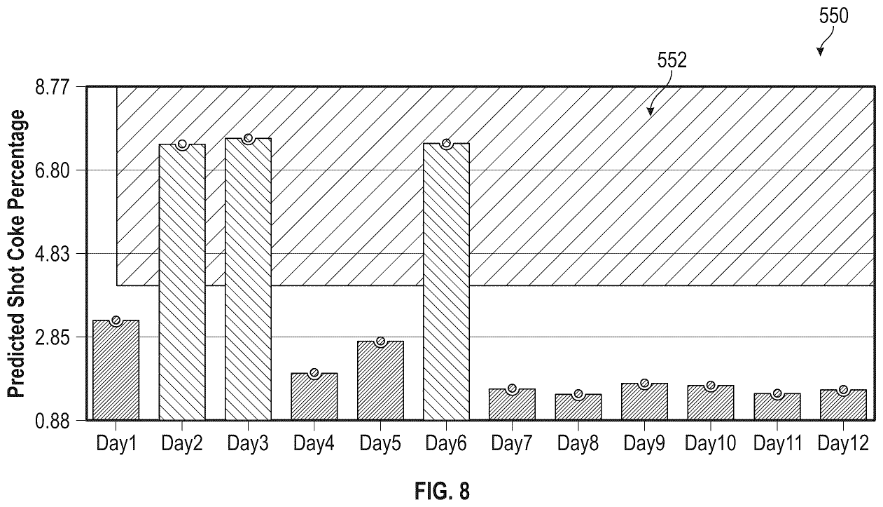

Referring to FIG. 8, a chart 550 is shown as an exemplary output generated by or from a coke quality prediction system (e.g., coke quality prediction system 400 shown in FIG. 4) is shown. Particularly, chart 550 depicts predicted shot coke percentage for each of a plurality of different days for a selected coke production system. The predicted shot coke percentage shown in chart 550 may be based on an input dataset specific to the selected coke production system and which may include, among other properties, feedstock properties, coke heating unit properties, and coke storage properties. The properties which drive the predicted shot coke percentage may change day-to-day as reflected in the daily variance in the predicted shot coke percentage depicted in chart 550. Additionally, chart 550 depicts an alarm region 552 defining a threshold (e.g., a user-defined threshold) predicted percentage of shot coke that may trigger an alarm to a user of the coke prediction system should the daily predicted shot coke percentage exceed this threshold.

While disclosed embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A computer-implemented method for predicting one or more parameters of calcinated coke produced by a coke production system, the method comprising:
(a) acquiring data indicative of at least one of one or more feedstock properties, one or more coke heating properties, or one or more coke storage properties;
(b) inputting the acquired data into a coke predictive model; and
(c) providing by the coke predictive model one or more predicted coke parameters corresponding to a feedstock received by the coke production system and based on the acquired data.

2. The method of claim 1, wherein the one or more coke parameters comprises a shot coke parameter.

3. The method of claim 2, further comprising:
(d) providing an alarm to a user of the coke predictive model in response to the shot coke parameter equaling or exceeding a predefined threshold.

4. The method of claim 1, wherein the one or more coke parameters comprises a vibrated bulk density parameter.

5. The method of claim 1, wherein the one or more coke parameters comprises a particle size parameter.

6. The method of claim 1, wherein the one or more feedstock properties includes at least one of a volatile matter property, a density property, a characterization factor property, a sulfur content property, a water content property, or a total acid number (TAN) property.

7. The method of claim 1, wherein the one or more coke heating properties comprises at least one of an air temperature property, an air flowrate property, a green coke flowrate property, or a heater operating temperature property.

8. The method of claim 1, wherein the one or more coke storage properties comprises a storage duration property, a storage location property, or a pile condition property.

9. The method of claim 1, wherein the one or more predicted coke parameters are produced by the coke predictive model in real-time following (b).

10. A computer-implemented method for predicting one or more parameters of calcinated coke produced by a coke production system, the method comprising:
(a) acquiring data indicative of at least one of one or more feedstock properties, one or more coke heating properties, or one or more coke storage properties;
(b) inputting the acquired data into a trained machine learning model; and
(c) providing by the trained machine learning model one or more predicted coke parameters corresponding to a feedstock received by the coke production system and based on the acquired data.

11. The method of claim 10, further comprising:
(d) acquiring one or more target coke parameters associated with the calcinated coke produced by the coke production system; and
(e) applying the one or more acquired target coke parameters to a machine learning algorithm to produce the trained machine learning algorithm.

12. The method of claim 11, wherein both the one or more predicted coke parameters and the one or more target coke parameters comprises at least one of a shot coke parameter, a vibrated bulk density parameter, or a particle size parameter.

13. The method of claim 11, wherein (e) comprises applying both the acquired target parameters and at least some of the acquired data that has been correlated with the calcinated coke associated with the one or more acquired target coke parameters.

14. The method of claim 10, wherein the one or more feedstock properties includes at least one of a volatile matter property, a density property, a characterization factor property, a sulfur content property, a water content property, or a total acid number (TAN) property.

15. The method of claim 10, wherein the one or more coke storage properties comprises a storage duration property, a storage location property, or a pile condition property.

16. The method of claim 10, wherein the one or more predicted coke parameters are produced by the trained machine learning model in real-time following (b).

17. A system comprising:
one or more processors; and
a storage device coupled to the one or more processors, the storage device configured to store instructions that, when executed by the one or more processors, configure the one or more processors to:
(a) acquire data indicative of at least one of one or more feedstock properties, one or more coke heating properties, or one or more coke storage properties;
(b) input the acquired data into a coke predictive model; and
(c) provide by the coke predictive model one or more predicted coke parameters corresponding to a feedstock received by a coke production system and based on the acquired data.

18. The system of claim 17, wherein the one or more predicted coke parameters comprises at least one of a shot coke parameter, a vibrated bulk density parameter, or a particle size parameter.

19. The system of claim 17, wherein the one or more feedstock properties includes at least one of a volatile matter property, a density property, a characterization factor property, a sulfur content property, a water content property, or a total acid number (TAN) property.

20. The system of claim 17, wherein the one or more coke storage properties comprises a storage duration property, a storage location property, or a pile condition property.
